(19) United States
(12) Patent Application Publication
(10) Pub. No.: US 2001/0016791 A1
(43) Pub. Date: Aug. 23, 2001

(54) Method for the detection of faulty installation of sensing devices in a vehicle

(76) Inventors: Oliver Bolzmann, Hannover (DE); Dirk Hothan, Neustadt (DE)

Correspondence Address: Proskauer Rose LLP, Patent Department, 1585 Broadway, New York, NY, 10036, US

(21) Appl. No.: 09/767,396

(22) Filed: Jan. 22, 2001

(30) Foreign Application Priority Data
Jan. 22, 2000 (DE) 100 02 685.0

(51) Int. Cl. G06F 17/00

(52) U.S. Cl. 701/34; 701/72; 701/75; 701/70

(57) ABSTRACT

A method for the detection of faulty installation of vehicular motion sensing devices compares the output signals of the sensing devices, which represent angular yawing speed values. Large deviations between these values are interpreted as installation errors, and a control unit causes the dynamic regulation of vehicle movement to be disabled. The particular type of installation error can also be determined by the inventive method, and presented on a display.

### FIELD OF THE INVENTION

The present invention relates to a method for the detection of faulty installation of sensing devices in a vehicle. More specifically, the present invention relates to a method for determining whether or not certain sensing devices, which monitor various signals that characterize the travel behavior of a vehicle, have been installed correctly.

### BACKGROUND OF THE INVENTION

In order to implement a travel dynamic regulation of a vehicle, as is known in the art from German patent application DE 195 15 051 A1 and European patent publication WO 95/26285 (U.S. Pat. No. 5,842,143) which are incorporated herein by reference, various sensing devices are attached to the vehicle to measure its angular yawing speed. That is, the vehicle's rotational speed around the normal axis can be determined. The sensing devices used for this measurement would preferably be an angular yawing speed sensor functioning on the gyroscope principle, a transversal acceleration sensor, and a steering angle sensor. One who is skilled in the art can use the signals from the transversal acceleration sensor and the steering angle sensor at a known vehicle speed, to then calculate a value of the angular yawing speed of the vehicle.

DE 195 15 051 A1 and WO 95/26285 disclose methods for travel dynamic regulation using sensing devices of the type mentioned above, and also disclose certain conversion rules to determine the yawing speed from the signals of the transversal acceleration sensors and the steering angle sensor.

If one of the sensing devices mentioned above has been installed incorrectly in a dynamic travel regulating system, the system cannot accomplish its intended task of stabilizing the behavior of the vehicle, due to erroneous signal transmissions from this sensing device. Under these conditions, undesirable regulating actions may take place. If, for example, the angular yawing speed sensor is installed so that it is rotated by 180 degrees from its desired angular position, i.e. upside down, the resultant values of the angular yawing speed signal would be incorrect.

It is therefore an object of the present invention to propose a simple and reliable method for the detection of incorrectly installed sensing devices in a vehicle, when they are used to sense values characterizing the vehicle's travel behavior.

### SUMMARY OF THE INVENTION

In accordance with an illustrative embodiment of the present invention, a method for the detection of faulty installation of sensing devices in a vehicle, wherein these sensing devices are used to measure certain operating parameters that characterize the travel behavior of the vehicle, comprises the steps of:

a) sensing at least one first and one second sequence of angular yawing speed values of the vehicle, by receiving signals from the sensing devices,

b) evaluating the signals from the sensing devices, and comparing the corresponding angular yawing speed values between the first and second sequences, and

c) recognizing a faulty installation of at least one of the sensing devices when a characteristic difference between the angular yawing speed values of the first and second sequences occurs.

The inventive method can be enhanced by requiring that the detection of a faulty installation of a sensing device take place only when a predetermined travel speed is exceeded.

Illustratively, the vehicle sensing devices include an angular yawing speed sensor, a transversal acceleration sensor, and a steering angle sensor, in addition to wheel speed sensors.

Furthermore, the inventive method compares the algebraic signs of corresponding angular yawing speed values of the first and second sequences to determine the specific type of installation error. The inventive method evaluates the algebraic sign comparisons to determine if a sensing device is rotated by 180 degrees relative to the vertical vehicle axis, or to the longitudinal vehicle axis, or to the transversal vehicle axis, relative to the desired angular position.

In another advantageous embodiment of the invention, an error is only recognized after the vehicle has passed at least a left turn followed by a right turn. This has the advantage that detrimental influences, such as a zero offset drift of the sensing devices, are compensated for, and do not result in an erroneous response from the error detection system. When such an error is detected, the travel dynamic regulation functions are disabled, and the type of error can be shown on a display for the benefit of the driver.

In another advantageous embodiment of the invention, the angular yawing speed sensor and the transversal acceleration sensor are installed in an electronic control unit. This configuration has the advantage that the sensing devices are well protected from damage, as well as from interfering environmental influences, such as moisture. Furthermore, the assembly of the above mentioned components is facilitated.

An illustrative embodiment of the present invention is more fully described below in conjunction with the following drawings.

### BRIEF DESCRIPTION OF THE DRAWINGS

FIG. 1 shows a schematic drawing of a vehicle configuration in accordance with the present invention.

FIG. 2 shows an electronic control unit with sensing devices installed in their preferred position in a vehicle, using the designation references of FIG. 1.

FIG. 3 shows a timing diagram of a preferred embodiment of the present invention.

### DETAILED DESCRIPTION OF THE INVENTION

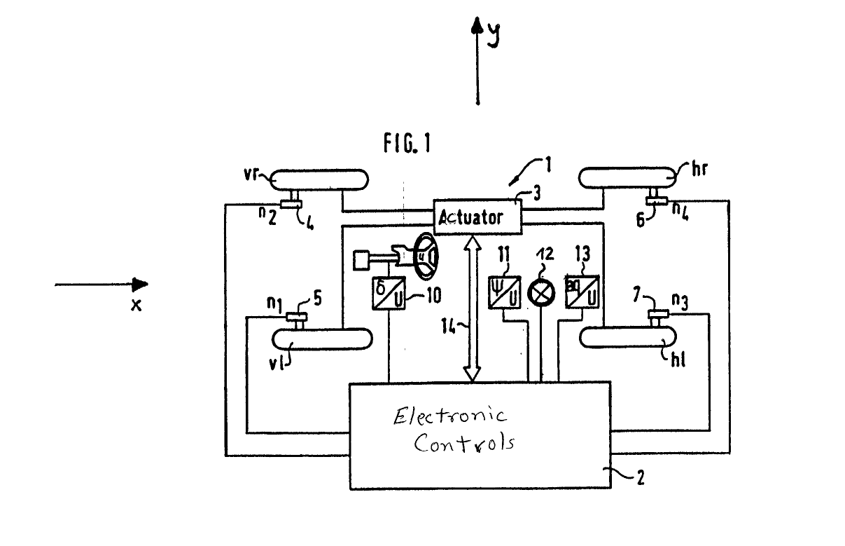

A vehicle 1, as shown in FIG. 1, with a longitudinal axis x, and a transversal axis y, has an arrangement for the evaluation of signals from an angular yawing speed sensor. This sensor is a component of an angular yawing speed regulating circuit, serving to stabilize the vehicle's travel behavior in the sense of a dynamic travel regulation. This regulating circuit comprises electronic controls 2, an actuator 3, and several sensors: four wheel speed sensors 4, 5, 6, 7, which measure the rotational speeds of the front right wheel vr, of the front left wheel vl, of the rear right wheel hr, and of the rear left wheel hl, respectively. Also shown are a steering angle sensor 10, the angular yawing speed sensor 11, and a transversal acceleration sensor 13. In addition, a display 12 is connected to electronic controls 2. The system may also include additional sensors and actuators not shown here.

Furthermore, vehicle 1 has a vertical axis z (not shown in FIG. 1) extending at a right angle to the plane of FIG. 1. The angular yawing speed is understood in this context to be the rotation of vehicle 1 around the vertical axis z, per time unit.

Steering angle sensor 10 serves to measure the steering angle selected by the driver, and which can be converted into the steering angle δ, by applying the transmission ratio of the steering gear in the applicable utilization. The steering angle δ is here understood to be the angular deviation of steerable wheels (vr, vl) from the longitudinal vehicle axis.

For the sake of simplification, it is assumed herein that steering angle sensor 10 emits a signal for steering angle δ, already corrected according to the transmission ratio of the steering gear.

Actuator 3 receives regulating signals from electronic controls 2 via a signal bus 14, and thereupon produces yawing moments; i.e., torque moments around the vertical axis z of vehicle 1. This can be preferably implemented by means of braking with different forces of the wheels on the left or on the right side of the vehicle. The operation of actuator 3 and sensors 4, 5, 6, 7, 10, 11, 13 are well known in the art, and are therefore not described here in any further detail. Electronic controls 2 receives the following signals from the sensors:

δ Steering angle, signal from sensor 10

\dot{ψ} angular yawing speed, signal from sensor 11

a_{q} transversal acceleration, signal from sensor 13

n₁ Wheel speed front left, signal from sensor 5

n₂ wheel speed front right, signal from sensor 4

n₃ wheel speed rear left, signal from sensor 7

n₄ wheel speed rear right, signal from sensor 6

From the sensor signals listed above, the angular gear speed of vehicle 1 can be calculated in various ways. Electronic controls 2 is preferably equipped with a digital microprocessor, which performs these calculations at a predetermined repetition rate. The individual, continuously calculated values of the angular gear speeds then appear as the sequences \dot{ψ}₁, \dot{ψ}₂, \dot{ψ}₃. From the signals of wheel speed sensors 4, 5, 6, 7, a vehicle speed v is calculated by using the applicable wheel circumference.

The sequence \dot{ψ}₁ is calculated from the steering angle δ, preferably according to the following equation:

$${\dot{Ψ}}_{1} ( δ ) = [ v / ( L + {E}_{g} \times {v}^{2} ) ] \times δ \qquad Equation [ 1 ]$$

In this case, L and E_{g} are values dependent on the vehicle geometry, L, indicating the wheelbase, and E_{g} the roll steer gradient. The roll steer gradient is a vehicle constant for the travel situation under consideration here, and is calculated by means of the following formula for a two-axle vehicle:

$${E}_{g} = [ {m}_{Fzg} \times ( {C}_{h} \times {L}_{h} - {C}_{v} \times {L}_{v} ) ] / L \times {C}_{v} \times {C}_{h} \qquad Equation [ 2 ]$$

In this case, m_{Fzg} designates the vehicle mass, Lₕ, the distance between the rear axle and the vehicle's center of gravity, Lᵥ, the distance between the front axle and the vehicle's center of gravity, Cᵥ, the slip angle stiffness of the front axle, and Cₕ, the slip angle stiffness of the rear axle. These values are vehicle-specific, and are found through tests. For a more detailed definition of the values mentioned above, see standard DIN 77000 of January, 1994.

The sequence \dot{ψ}₂ is calculated from the transversal acceleration a_{q}, preferably according to the following equation:

$${\dot{Ψ}}_{2} ( {a}_{q} ) = {a}_{q} / v \qquad Equation [ 3 ]$$

The sequence \dot{ψ}₃ is directly equal to the individual angular yawing speed values found by the angular yawing speed sensor 11:

$${\dot{Ψ} }_{3} ( \dot{Ψ} ) = \dot{Ψ} \qquad Equation [ 4 ]$$

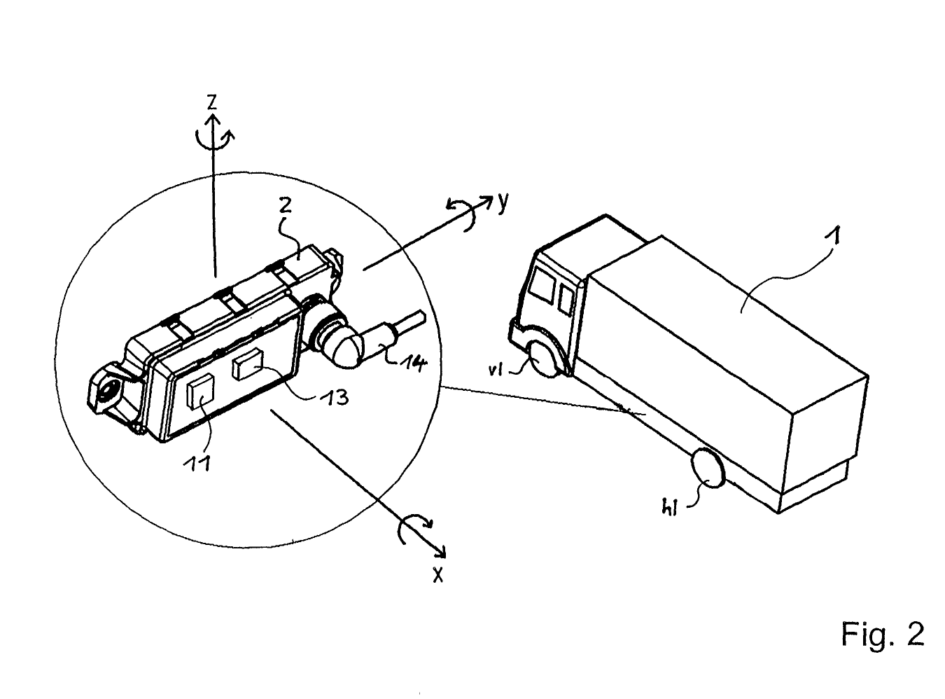

FIG. 2 shows electronic controls 2, as well as its preferred installation position in vehicle 1. As shown in FIG. 2, electronic controls 2 represents a preferred embodiment of the controls shown in FIG. 1, in which the angular yawing speed sensor 11, as well as the transversal acceleration sensor 13, are structurally integrated into electronic controls 2. As a result, the possibility of incorrect installation of the sensors 11, 13 is reduced, since that could only occur as a result of incorrect installation of electronic controls 2. Since the relative positions of sensors 11 and 13 are permanently predetermined, the manner in which electronic controls 2 is installed, i.e., around which of the three spatial axes x, y, z it is rotated, can be ascertained from the signals of these sensors, in order to determine whether or not there is an installation error.

The following discussion assumes that the configuration of electronic controls 2 is as shown in FIG. 2.

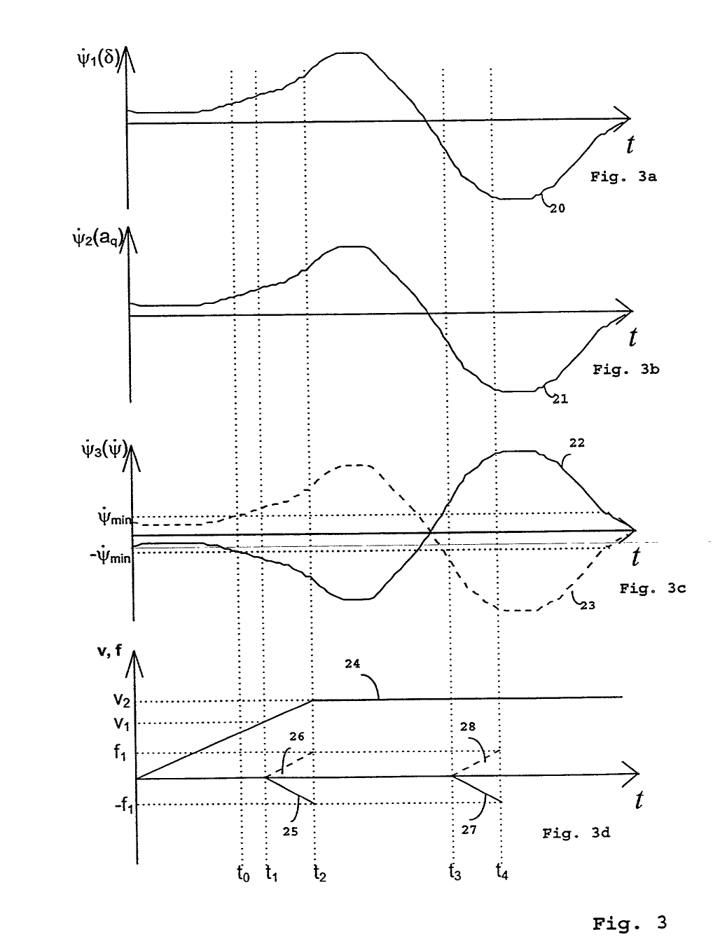

Referring now to FIG. 3, the course of the sequences \dot{ψ}₁, \dot{ψ}₂, \dot{ψ}₃, representing the angular yawing speed values, are shown in the timing diagrams of FIGS. 3a, 3b, and 3c, respectively, in the form of variations in time 20, 21, 22, and 23. Furthermore, the vehicle speed v and an error counter f are shown together in the timing diagram of FIG. 3d, on the same time scale. In this example, the vehicle travels first through a left curve, followed immediately by a right curve.

As shown in diagram 3d, the vehicle starts to accelerate from zero velocity until it reaches velocity v₂. During this acceleration phase, the travel curve begins, which can be recognized from a noticeable increase in angular yawing speed values. In order to avoid erroneous actuation of the error recognition system, as in the case of low-level sensor signals caused by overlapping interference levels, an evaluation of the angular yawing speed values does not begin until a sensor-specific minimum angular yawing speed value (\dot{ψ}ₘᵢₙ, −\dot{ψ}ₘᵢₙ) is reached, an event taking place at point in time t₀ in FIG. 3. In addition, the error is recognized only when a predetermined minimum speed v₁ has been reached or exceeded. An appropriate selection of this minimum speed v₁, e.g., 30 km/h, ensures a reliable signal emission by all sensors. In addition, erroneous actuation of the error recognition system, due to reverse travel, can be avoided if the previously mentioned minimum speed is selected at a sufficiently high level. The minimum speed v₁ is reached at the point in time t₁ in FIG. 3.

When the error recognition function has been launched, i.e., starting at point in time t₁, electronic controls 2 monitors the sequences \dot{ψ}₁, \dot{ψ}₂, \dot{ψ}₃ for algebraic signs and amounts.

To distinguish among errors, the algebraic signs of the sequences \dot{ψ}₁, \dot{ψ}₂, \dot{ψ}₃ are designated as algebraic sign values S₁, S₂, S₃, where:

S₁=Sgn (\dot{ψ}₁) Equation [5]

S₂=Sgn (\dot{ψ}₂) Equation [6]

S₃=Sgn (\dot{ψ}₃) Equation [7]

As such, the algebraic sign values S₁, S₂, S₃ contain the value +1 in the case of a positive algebraic sign, and the value −1 in the case of a negative algebraic sign.

Using the algebraic sign values S₁, S₂, S₃, it is possible to differentiate between different installation errors of electronic controls 2, in accordance with the following table, the contents of which are stored in electronic controls 2.

TABLE 1

| Traveling | | |
|---|---|---|
| state | S₁ S₂ S₃ | Type of Error |
| Left curve | +1 +1 +1 | Controls 2 is installed correctly, i.e., no error. |
| Right curve | −1 −1 −1 | |
| Left curve | −1 +1 +1 | Controls 2 is turned around by 180 degrees |
| Right curve | +1 −1 −1 | with respect to the longitudinal vehicle axis (x), |
| | | and with respect to the desired angular position. |
| Left curve | +1 +1 −1 | Controls 2 is turned around by 180 degrees |
| Right curve | −1 −1 +1 | with respect to the transversal vehicle axis (y), |
| | | and with respect to the desired angular position. |
| Left curve | +1 −1 +1 | Controls 2 is turned around by 180 degrees |
| Right curve | −1 +1 −1 | with respect to the vertical vehicle axis (z), |
| | | and with respect to the desired angular position. |

Referring to the sequences shown in FIG. 3 as an example of an embodiment, the sequence \dot{ψ}₂(a_{q}), according to FIG. 3b, is compared to the sequence \dot{ψ}₁(δ), according to FIG. 3a, in a first comparison criterion. As can be seen from FIGS. 3a and 3b, the time variation of sequences \dot{ψ}₁, \dot{ψ}₂ is substantially the same, with respect to amount as well as to algebraic sign. Thus, there is no resultant triggering of the error recognition system, since no indication is present for an erroneous installation of transversal acceleration sensor 13, or of electronic controls 2.

In a second comparison criterion, the sequence \dot{ψ}₃ (\dot{ψ}), according to FIG. 3c, is compared to the sequence \dot{ψ}₁(δ), according to FIG. 3a. In this case, it is indicated that electronic controls 2, and thereby also angular yawing speed sensor 11, are installed so as to be turned 180 degrees relative to the vehicle axis y, and relative to the desired angular position, thus representing an error in installation. This error must be recognized in order to avoid undesirable actuation of the dynamic regulation of vehicle movement. As a consequence of this incorrect installation, the angular yawing speed sequence \dot{ψ}₃, as measured by angular yawing speed sensor 11, is represented by the variation in time 22 in FIG. 3c. The variation in time 23, which is indicated in FIG. 3c by a broken line, shows the theoretical progression of the sequence \dot{ψ}₃ when electronic controls 2 and angular yawing speed sensor 1 are installed correctly.

In a third comparison criterion, the sequence \dot{ψ}₃(\dot{ψ}), according to FIG. 3c, can be compared with the sequence \dot{ψ}₂(a_{q}), according to FIG. 3b. As can be seen in FIG. 3, sequences \dot{ψ}₂, \dot{ψ}₃ also have two courses that are significantly different, and, in particular, have different algebraic signs, again indicating an installation error.

Following the start of the vehicle, interventions by the dynamic regulation of vehicle movement are initially blocked, until electronic controls 2 has determined that the sensing means have been installed correctly, by carrying out the error recognition function, according to the inventive method. In the representation of FIG. 3d, and at the point in time t₁, the error recognition function is launched, once the vehicle speed v has reached or exceeded the minimum speed value v₁, and when certain minimum amounts \dot{ψ}ₘᵢₙ,−\dot{ψ}ₘᵢₙ of the angular yawing speed values are present. Electronic controls 2 uses the previously mentioned comparison criteria to compare the sequences with each other for different algebraic signs. Different algebraic signs occur in the example of FIG. 3 between the sequences \dot{ψ}₁ and \dot{ψ}₃, and between the sequences \dot{ψ}₂ and \dot{ψ}₃. These sign differences trigger electronic controls 2 to start continuous decrementing of an error counter f, as shown in FIG. 3d by line 25. If the algebraic signs had been identical, electronic controls 2 would have incremented the error counter f, as shown by the broken line 26 in FIG. 3d.

At the point in time t₂, error counter f has reached a threshold value −f₁, indicating an erroneous installation of a sensing device. Electronic controls 2 then stores this information, that a suspected installation error was recognized during a left turn. However, no final determination is made at this point that an error exists, respectively, in the case of the broken-line courses 23, 26, or the presence of a faultless system of dynamic regulation of vehicle movement.

Electronic controls 2 preferably continues to observe the sequences \dot{ψ}₁, \dot{ψ}₂, \dot{ψ}₃ until the vehicle goes into a right curve, although the sequence of the curve directions is of no significance for the recognition of installation error. That is, a defective or a correct state is recognized after a left curve and a following right curve, or after a right curve and a following left curve.

At the point in time \dot{ψ}₃, the vehicle is engaged in a curve sufficient for an evaluation of the angular yawing gear speed values, at a sufficiently high travel speed v₂, above the minimum speed v₁. Due to the continued difference in algebraic signs between the sequences \dot{ψ}₁ and \dot{ψ}₃, error counter f is decremented in a manner analogous to the one described above (solid line 27 in FIG. 3d), and reaches the error recognition threshold value −f₁ at time t₄. At this point, electronic controls 2 recognizes the installation error, and locks all the functions of the dynamic regulation of vehicle movement for the duration of the travel.

By comparing the algebraic sign values S₁, S₂, S₃ with the values indicated in Table 1, electronic controls 2 further recognizes the type of installation error, and stores these in a non-volatile memory, in order to simplify subsequent error search and repair. In addition, electronic controls 2 actuates display 12, and thus signals the installation error to the driver. Therefore, the driver is also informed that the regulating functions of the dynamic regulation of vehicle movement are not available. The type of error is displayed by means of display 12 in an advantageous embodiment of the invention, e.g., by means of a blinking code.

In the case of a correct installation of all the sensing devices, the error counter f would assume the course shown by the broken line 28, in a curve to the right. In this case, electronic controls 2 would launch the dynamic regulating function of vehicle movement, after having recognized and stored the course 26 of error counter f.

In short, a method for the detection of a faulty installation of vehicle sensing devices is disclosed. Moreover, the disclosed method has the advantage of being relatively easy and economical to implement by means of a software sub-program in electronic controls of conventional design. An additional advantage of the present invention is that different types of installation errors, as described heretofore, can be detected rapidly.

The above described embodiments of the present invention are intended to be illustrative only. Numerous alternative embodiments may be devised by those skilled in the art without departing from the spirit and scope of the following claims.

1. A method for the detection of faulty installation of sensing devices in a vehicle, wherein said sensing devices are used to measure certain operating parameters that characterize the travel behavior of said vehicle, comprising the steps of:
a. sensing at least one first and one second sequence of angular yawing speed values of said vehicle, by receiving signals from said sensing devices,
b. evaluating said signals from said sensing devices, and comparing the corresponding angular yawing speed values between said first and said second sequences, and
c. recognizing a faulty installation of at least one of said sensing devices when a characteristic difference between the angular yawing speed values of said first sequence and said second sequence occurs.

2. The method of claim 1, wherein the detection of a faulty installation of a sensing device takes place only when a predetermined travel speed is exceeded.

3. The method of claim 1, wherein said sensing devices include an angular yawing speed sensor.

4. The method of claim 1, wherein said sensing devices include a transversal acceleration sensor.

5. The method of claim 1, wherein said sensing devices include a steering angle sensor.

6. The method of claim 1, wherein the algebraic signs of said corresponding angular yawing speed values of said at least one first and one second sequence are compared with each other to recognize an error.

7. The method of claim 1, wherein an error can be recognized when said vehicle has traveled at least through one left curve and one right curve.

8. The method of claim 3, wherein said angular yawing speed sensor is located in an electronic control unit.

9. The method of claim 4, wherein said transversal acceleration sensor is located in said electronic control unit.

10. The method of claim 9, wherein a distinction is made between at least two of the following types of errors:
a) said electronic control unit is installed so as to be rotated by 180 degrees relative to the vertical vehicle axis compared to the desired angular position,
b) said electronic control unit is installed so as to be rotated by 180 degrees relative to the longitudinal vehicle axis compared to the desired angular position,
c) said electronic control unit is installed so as to be rotated by 180 degrees relative to the transversal vehicle axis compared to the desired angular position.

11. The method of claim 10, wherein a detected error is presented on a display.

12. The method of claim 11, wherein a type of said detected error is presented on said display.
